(19) United States
(12) Patent Application Publication
(10) Pub. No.: US 2017/0241163 A1
(43) Pub. Date: Aug. 24, 2017

(54) LOCK ASSEMBLY WITH DETECTION FUNCTION

(71) Applicant: WFE TECHNOLOGY CORP., Taichung City (TW)

(72) Inventor: Jack Lien, Taichung City (TW)

(21) Appl. No.: 15/047,135

(22) Filed: Feb. 18, 2016

(51) Int. Cl. E05B 45/08; E05B 15/16; E05B 27/00; E05B 45/06; E05B 45/10

(52) U.S. Cl. CPC E05B 45/08; E05B 45/06; E05B 45/10; E05B 27/0017; E05B 27/0057; E05B 15/1614

(57) ABSTRACT

A lock assembly includes an outer body defining a hollow chamber, at least one pin-reception chamber located exterior of and in spatial communication with the hollow chamber and a plug unit disposed at an outer peripheral portion thereof in alignment with the pin-reception chamber; a cylinder mounted rotatably in the hollow chamber, having a distal end formed with an axial key passage and a peripheral wall formed with a pin channel in alignment with the pin-reception chamber and in spatial communication with the key passage; at least one driver pin unit disposed movably between the pin channel in the cylinder and the pin-reception chamber in the outer body; and a detection device installed to the plug unit in such a manner that the detection device is aligned with the driver pin unit is activated to output a signal upon detecting movement of the driver pin unit.

### BACKGROUND OF THE INVENTION

1. Field of the Invention

The present invention relates generally to a lock assembly, and more particularly to a lock assembly having a detection function.

2. The Prior Arts

Due to rapid development of electronic technology, majority of conventional home appliances or consumer commodity cannot avoid being employed with electronic devices. For instance, a conventional lock assembly we use to lock our doors when going out, is at least partially employed with some electronic gadgets so as to enhance its original function, or else will be discarded in the near future.

However, one cannot deny that the original function of the conventional lock assembly still exists regardless of integrating some electronic gadgets in the conventional lock assembly. In case of shortage of supply for the electronic gadgets or when the function of those electronic gadgets employed in the lock assembly fails, the user must insert the key into the lock body so as to unlock the doors. To be more specific, each lock assembly should have a mechanically operated structure to doubly ensure its usage is the current trend for the manufacturers of the lock assemblies.

Under the presently existing technology, it is customary to provide some anti-theft system in electric lock assembly in order to prevent an intruder from entering into a house. Some anti-theft system includes a plurality of detection or sensing apparatuses, which are generally and interactively connected with the electric lock assembly. It is noted that if the thief is clever enough or has background with electronics, he still can cut off the electrical connection, thereby rendering these anti-theft system useless. In addition, if the thief is skilled in the mechanics, with the assistance of some simple tool, he can easily unlock the conventional lock assembly and hence entering into the house without any difficulty. Presently, some conventional lock assemblies have relatively sophisticated structures in order to prevent from picking or to provide anti-theft effect, but their costs are also relatively expensive. Hence, there is a need to invent a lock assembly consisting of mechanical and electronic structures with low cost to create a safer environment.

### SUMMARY OF THE INVENTION

A primary objective of the present invention is to provide a lock assembly with detection function such that whether the lock assembly is activated by an original key of other tool, the lock assembly is capable of detecting the activation of key pins therein so as to generate an alarm, thereby providing an anti-theft effect.

A lock assembly with detection function of the present invention includes an outer body, a cylinder, at least one driver pin unit and a detection device.

The outer body defines a hollow chamber, a central axis extending through the hollow chamber, at least one pin-reception chamber located exterior of and in spatial communication with the hollow chamber and a plug unit disposed at an outer peripheral portion thereof in alignment with the pin-reception chamber.

The cylinder is mounted rotatably in the hollow chamber, and has a distal end formed with a key passage extending along an axis of the cylinder and a peripheral wall formed with a pin channel in alignment with the pin-reception chamber and in spatial communication with the key passage.

The driver pin unit is disposed movably between the pin channel in the cylinder and the pin-reception chamber in the outer body.

The detection device is installed to the plug unit in such a manner that the detection device is aligned with the driver pin unit so as to be activated to output a signal upon detecting movement of the driver pin unit.

Preferably, the outer body has four pairs of the pin-reception chambers and the peripheral wall of the cylinder is formed with four pairs of the pin channels respectively aligned and in spatial communication with the pin-reception chambers and wherein four pairs of driver pin units are disposed movably between the pin channels in the cylinder and the pin-reception chambers in the outer body.

In this embodiment, the four pairs of pin-reception chambers of the outer body are spaced apart from one another at 90 degree of the central axis in clockwise or anticlockwise directions and the four pairs of pin channels of the cylinder are spaced apart from one another at 90 degree with respect to an axis of the cylinder in clockwise or anticlockwise direction while the axial key passage is configured as a cross in cross-section.

In this embodiment, each driver pin unit includes an interior pin disposed movably in a respective one of the pin channels and extending partially into a respective one of the pin-reception chambers, and an exterior pin disposed movably within the respective one of the pin channels in abutment with the interior pin and extending partially into the key passage.

The lock assembly of the present invention further includes an alarm system that is adapted to be coupled electrically with the detection device.

The lock assembly of the present invention further includes an anti-pry plate mounted on an external surface of the outer body to prevent picking of the axial key passage so as to avoid a theft.

The lock assembly of the present invention provides the following advantages:

Due to presence of the detection device in alignment with the driver pin unit in the lock assembly of the present invention, in case the lock assembly is required to be unlocked by insertion of an original key or in case the key passage of the lock assembly is picked by a tool, movement of the driver pin unit will result in activation of the detection device so as to output a signal to an alarm system electrically connected with the detection device, thereby generating an alarm, like buzzing sounds, whistling sound or flashing lights to warn the intruder.

Since an anti-pry plate is mounted on the external surface of the outer body and once the lock assembly is mounted on a door and a door frame, the anti-pry plate is flush with or abutted with one frame side of the door frame and the other frame side to which the door is hinged thereat. Under this condition, the detection device is shielded by the anti-pry plate and a stranger or an intruder outside the door does not know the lock assembly of the present invention is installed with the detection device, thereby providing an additional safety to the house.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a lock assembly with detection function of the present invention;

FIG. 2 is a fragmentary cross-sectional view of the lock assembly with detection function of the present invention prior to a key being inserted into a cylinder of the lock assembly;

FIG. 3 is a fragmentary cross-sectional view of the lock assembly with detection function of the present invention when the key is inserted into the cylinder of the lock assembly for unlocking the same; and

FIG. 4 is a fragmentary cross-sectional view of the lock assembly with detection function of the present invention being picked by an intruder using a tool.

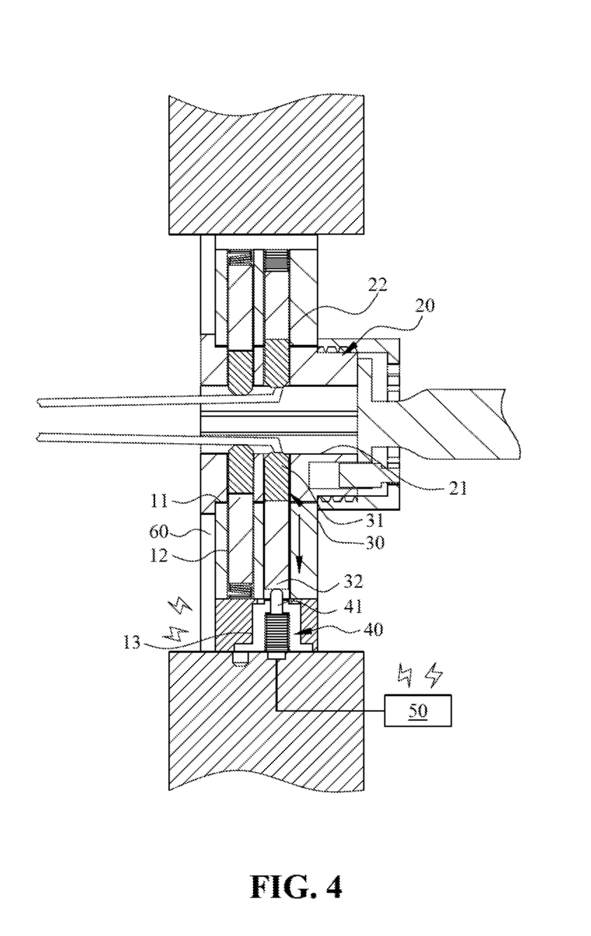

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

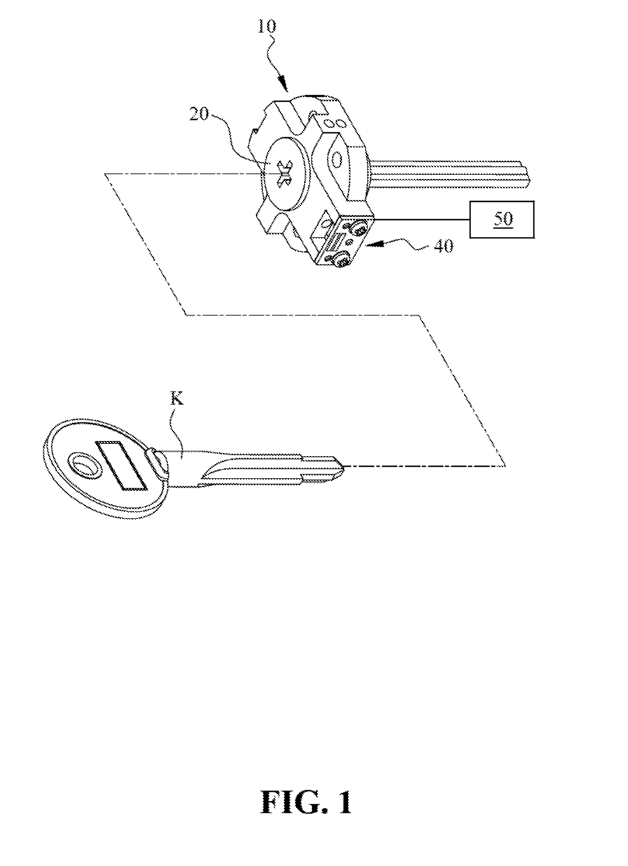

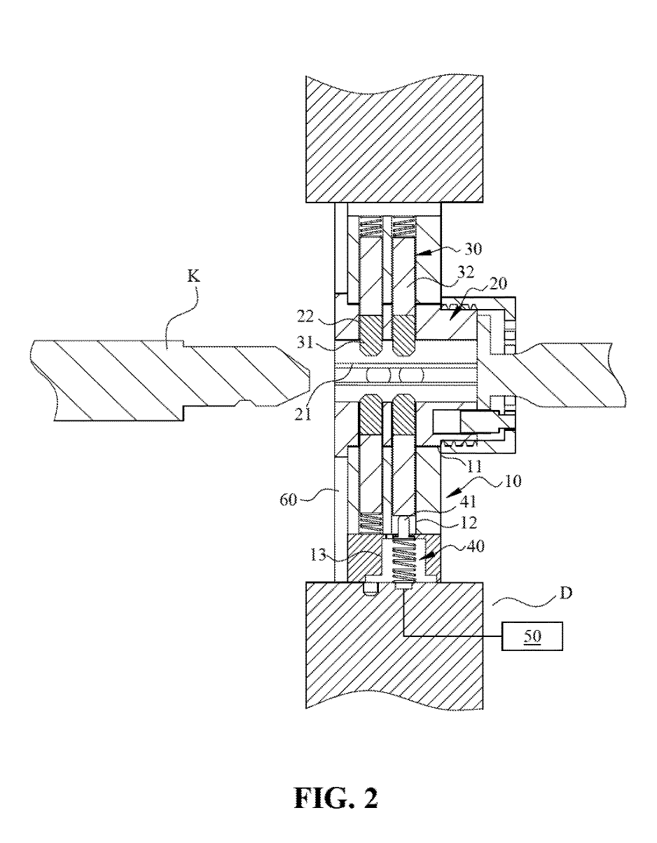

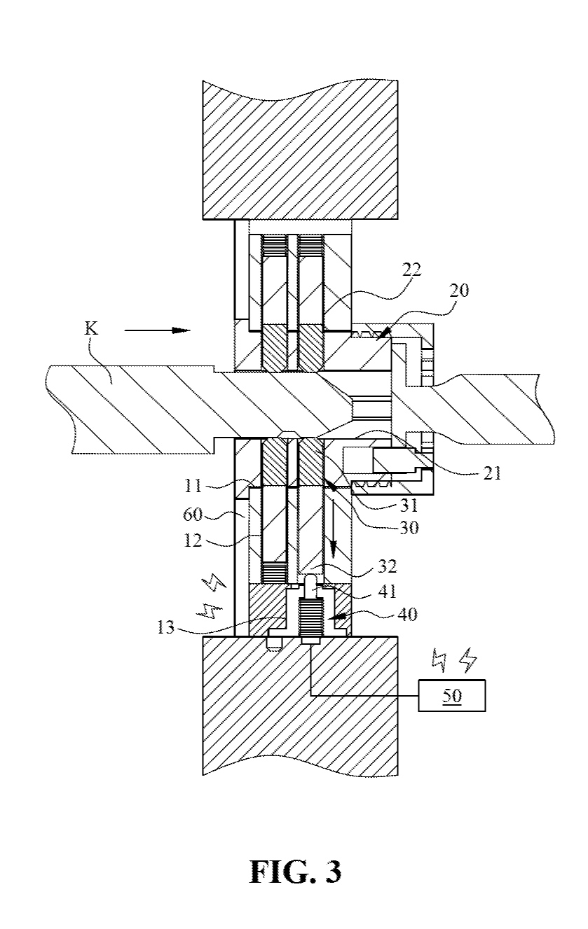

Referring to FIGS. 1-3, wherein FIG. 1 is a perspective view of a lock assembly with detection function of the present invention; FIG. 2 is a fragmentary cross-sectional view of the lock assembly with detection function of the present invention prior to a key being inserted into a cylinder of the lock assembly; and FIG. 3 is a fragmentary cross-sectional view of the lock assembly with detection function of the present invention when the key is inserted into the cylinder of the lock assembly for unlocking the same. As illustrated, the lock assembly of the present invention includes an outer body 10, a cylinder 20, at least one driver pin unit 30 and a detection device 40.

The outer body 10 defines a hollow chamber 11, a central axis extending through the hollow chamber 11, at least one pin-reception chamber 12 located exterior of and in spatial communication with the hollow chamber 11 and a plug unit 13 disposed at an outer peripheral portion of the outer body 10 in alignment with the pin-reception chamber 12. In this embodiment, Euro or American type cylindrical core available in the market can be selected for serving as the outer body 10. To be more specific, the outer body 10 has four pairs of pin-reception chambers 12 which are angularly spaced apart from one another at 90 degree with respect to the central axis in clockwise or anticlockwise direction. Note that the outer peripheral portion of the outer body 10 is formed with a radially and inwardly dented recess, the purpose of which will be described later in the following paragraphs.

The cylinder 20 is mounted rotatably in the hollow chamber 11 of the outer body 10 in a conventional manner. The cylinder 20 has a distal end that is generally exposed to an external surface of the outer body 10 and that is formed with a key passage 21 extending along an axis of the cylinder 20, and a peripheral wall that is formed with a pin channel 22 in alignment with the pin-reception chamber 12 and in spatial communication with the key passage 21. In this embodiment, the peripheral wall of the cylinder 20 has four pairs of pin channels 22 which are spaced apart from one another at 90 degree with respect to the axis of the cylinder 20 in clockwise or anticlockwise direction. To be more specific, the four pairs of pin channels 22 in the cylinder 20 are respectively aligned and in spatial communication with the pin-reception chambers 12 in the outer body 10. Note that the key passage 21 is configured as a cross in cross-section so as to be compatible with the key K (see FIG. 2).

The driver pin unit 30 is disposed movably between the pin channel 22 in the cylinder 20 and the pin-reception chamber 12 in the outer body 10. Preferably, four pairs of driver pin units 30 are implemented in this embodiment. Each driver pin unit 30 includes an interior pin 31 disposed movably in a respective one of the pin channels 22 and extending into the axial key passage and a spring-biased exterior pin 32 disposed movably within the respective one of the pin channels 22 in abutment with the interior pin 31 and extending into a respective one of the pin-reception chambers 12 in the normal condition (before the key is inserted into the key passage 21). Under this condition, the key K can be inserted into the key passage 21 so as to actuate the driver pin units 30. To be more specific, rotation of the key K together with the cylinder 20 relative to the outer body 10 results in simultaneous pressing the interior pins 31 to retract inwardly into the pin channels 22 in the cylinder 20 while the exterior pins 32 are retracted fully into the pin-reception chambers 12 in the outer body 10 against the biasing action of the springs. The door (not visible) can be opened since a latch (not visible) installed in the lock assembly of the present invention has disengaged from a latch opening (not visible) of the door frame D. Regarding installation of the latch in the lock assembly of the present is not related to the structure of the present invention, a detailed description of the latch is omitted herein for the sake of brevity.

The detection device 40 is installed to the plug unit 13, which is fitted in the dented recess in the outer peripheral portion of the outer body 10, in such a manner that the detection device 40 is aligned with one of the driver pin units 30 so as to be activated to output a signal upon detecting movement of the driver pin unit 30. In this embodiment, the detection device 40 is provided with a contact stem 41 in contact with at least one of the exterior pins 32 such that movement of the exterior pin 32 (retraction of the exterior pin 32 fully into the pin-reception chambers 12) will compress the stem 41 so that the detection device 40 is activated to generate and transmit a signal.

Referring again to FIGS. 2 and 3, the lock assembly of the present invention further includes an alarm system 50 that is adapted to be coupled electrically with the detection device 40. To be more specific, the alarm system 50 is generally installed on the door frame D or somewhere nearby the door installed with the lock assembly of the present invention and is further electrically connected with the detection device 40 such that upon activation of the detection device 40 and upon receiving the signal will generate an alarm signals or sound, like buzzing or warning sounds used by police car and ambulances. Note that the alarm system 50 is adapted to generate different kinds of warning sounds or colorful flashing light used by police car and these functions can be set in advance by the user of the lock assembly of the present invention. As illustrated in FIG. 3, when the driver pin units 30 are actuated by the inserted key K or the lock assembly of the present invention is picked by an intruder using a tool K1 so as to retract at least one of the interior pins 31 inwardly into the respect pin channel 22, hence compressing the stem 41 of the detection device 40. At this time, the alarm system 50 will generate the alarm sound or signal which is set in advance according to the required mode of the user of the lock assembly of the present invention.

Preferably, the lock assembly of the present invention may further includes an anti-pry plate 60 mounted on an external surface of the outer body 10 to prevent picking of the axial key passage 21 so as to avoid a theft. To be more specific, the anti-pry plate 60 is flush with or abutted with one frame side of the door frame D, the detection device 40 is shielded by the anti-pry plate 60 and a stranger or an intruder outside the door does not know the lock assembly of the present invention is installed with the detection device 40, thereby providing an additional safety to the house.

Although the present invention has been described with reference to the preferred embodiments thereof, it is apparent to those skilled in the art that a variety of modifications and changes may be made without departing from the scope of the present invention which is intended to be defined by the appended claims.

1. A lock assembly comprising:
an outer body defining a hollow chamber, a central axis extending through said hollow chamber, said outer body further having a pin-reception chamber located exterior of and in spatial communication with said hollow chamber and a plug unit disposed at an outer peripheral portion thereof in alignment with said pin-reception chamber;
a cylinder mounted rotatably in said hollow chamber, having a distal end formed with a key passage extending along an axis of said cylinder and a peripheral wall formed with a pin channel in alignment with said pin-reception chamber and in spatial communication with said key passage;
a driver pin unit disposed movably between said pin channel in said cylinder and said pin-reception chamber in said outer body;
wherein said outer body has four pairs of said pin-reception chambers and wherein said peripheral wall of said cylinder is formed with four pairs of said pin channels respectively aligned and in spatial communication with said four pairs of pin-reception chambers and wherein four of the driver pin units are disposed movably between said pin channels in said cylinder and said pin-reception chambers in said outer body and wherein each of said driver pin units includes an interior pin disposed movably in a respective one of said pin channels and extending into said axial key passage and a spring-biased exterior pin disposed movably within the respective one of said pin channels in abutment with said interior pin and extending into a respective one of said pin-reception chambers;
wherein said four pairs of pin-reception chambers of said outer body are angularly spaced apart from one another at a degree of 90° with respect to said central axis in clockwise or anticlockwise directions and wherein said four pairs of pin channels of said cylinder are angularly spaced apart from one another at a degree of 90° with respect to said axis of said cylinder in clockwise or anticlockwise directions while said axial key passage is configured as a cross in cross-section; and
a detection device installed to said plug unit and provided with a contact stem in contact with at least one of said exterior pins such that movement of said exterior pin will compress the stem so that the detection device is activated to generate and transmit a signal.

2-4. (canceled)

5. The lock assembly according to claim 1, further comprising an alarm system that is adapted to be coupled electrically with said detection device.

6-8. (canceled)

9. The lock assembly according to claim 1, further comprising an anti-pry plate mounted on an external surface of said outer body to prevent picking of the axial key passage so as to avoid a theft.

10-16. (canceled)
